(19) United States
(12) Patent Application Publication
(10) Pub. No.: US 2005/0077246 A1
(43) Pub. Date: Apr. 14, 2005

(54) Treatment of liquid using porous polymer containment member

(76) Inventors: James J. Pardini, Flemington, NJ (US); Francis J. Fischer, Easton, PA (US)

Correspondence Address: PEARNE & GORDON LLP, 1801 EAST 9TH STREET, SUITE 1200, CLEVELAND, OH, 44114-3108, US

(21) Appl. No.: 10/925,186

(22) Filed: Aug. 24, 2004

Related U.S. Application Data
(63) Continuation-in-part of application No. 10/195,630, filed on Jul. 15, 2002.
(63) Continuation-in-part of application No. 10/195,875, filed on Jul. 15, 2002.
(63) Continuation-in-part of application No. 10/195,876, filed on Jul. 15, 2002.

(51) Int. Cl. B01D 15/08

(52) U.S. Cl. 210/724

(57) ABSTRACT

The present invention features a device for treating liquid including a containment member comprised of rigid porous polymer configured to form a containment space. Nonbonded particulate media is disposed in the space in contact with and contained by the containment member. Pores in the containment member are characterized by pore paths and pore sizes effective to permit flow of liquid through the pores while preventing the media from traveling through the pores. The containment member may be in various shapes and include different numbers of components. One variation of the containment member includes first and second containment layers comprised of the rigid porous polymer, which are configured and arranged so as to form a space therebetween in which the media is contained. Another variation of the containment member includes first and second porous polymer tubes forming a space in which the media is contained. Also featured is a method of using the device. Another aspect of the invention is a system that includes the device and a pH adjuster device that may function as an acidifier or basifier, which improves the performance of the liquid treatment device in removing substances from liquids by raising or lowering the pH of the influent traveling through the media of the liquid treatment device.

### RELATED INVENTIONS

This is a continuation-in-part of co-pending U.S. patent application Ser. Nos. 10/195,630, filed Jul. 15, 2002; 10/195,875, filed Jul. 15, 2002 and 10/195,876, filed Jul. 15, 2002.

### FIELD OF THE INVENTION

The present invention relates to treating liquid and, in particular, to removing substances from liquid, including dissolved substances.

### BACKGROUND OF THE INVENTION

There are a myriad of filtration and water treatment devices that utilize a variety of containment materials and media. One device is disclosed in U.S. Pat. No. 4,104,170. This patent discloses particulate activated charcoal contained between inner and outer polypropylene paper in a tubular shape. The outer paper is in the form of pleats. The device requires a central core member in order to provide strength to the assembly.

U.S. Pat. No. 5,082,568 discloses a water filter that includes a tubular block of bonded carbon. The outer surface of the block includes an inner wrap of polyolefin filter material and an outer wrap of polypropylene. The inner surface of the block includes a polypropylene wrap.

U.S. Pat. No. 5,597,489 discloses removing contamination from ground water using a radial flow device that includes inner and outer cylindrical screens and particulate media disposed therebetween.

U.S. Pat. No. 6,322,704 discloses a radial flow fluidizable filter comprising concentric tubes of perforated plastic and unbonded particulate media disposed in a radial space between the tubes. The device employs a screen between the media and the tubes for preventing media from being lost though the holes in the tubes.

U.S. Pat. No. 4,894,149 discloses a biological filtration device including a perforated core, an outer cylindrical perforated sheath and particulate media such as sand or gravel located between them. The holes in the core and sheath are smaller than the media to prevent loss of media through the holes.

U.S. Pat. No. 5,290,443 discloses a faucet mounted filter comprising a central perforated tube around which is wound a spiral ultrafiltration membrane. The filter has pores on the order of 0.02 microns that are small enough to remove microbes from liquids.

U.S. Pat. No. 5,328,609 discloses a multistage radial flow filtration system. The first stage includes two concentric tubular filter elements, an outer element comprising molded, spun fibrous material and an inner element comprising carbonaceous material cast from powdered carbon. The second stage filter comprises a tube made of cast carbon filter media.

U.S. Pat. No. 4,761,232 discloses porous structures made of porous resins. The material is characterized by a porous network structure. The owner of the '232 patent, Porex Technologies Corp., disclosed in its website (www.Porex.com) that filtration tubes may be made of porous plastic material. This would strain particles from liquids that are larger than can pass through the pores of the tubes.

The industry could benefit from a device employing nonbonded particulate media that does not require membranes, screens or paper. Screens cannot be made to contain small particles of media. Membranes are expensive to fabricate and membranes and filter paper are not robust. In applications such as drinking water treatment, failure of a membrane can result in breakthrough of the media bed and the hazard of drinking water containing toxins such as arsenic unknowingly entering the water supply.

Filtration devices do not face the same concerns as devices for treating liquids by adsorption or ion exchange. If there is a thin section of the media bed such as might be caused by nonuniform charging of the media or irregularity in the porous containment material, a filtration device is self-correcting in that the thin section may become blocked and divert flow to other locations of the bed. However, in the case of devices for treating water by adsorption or ion exchange, nonuniform beds of media are susceptible to breakthrough at regions of nonuniformity (e.g., thin sections), which leads to shortened life or hazardous operation of the device when used for removing toxic contaminants such as arsenic.

It would advance the industry if a device could remove small molecules of chemical species from feed liquids. It would be desirable if the device could provide high removal efficiency using fine nonbonded particulate media without an excessive pressure drop across the device rather than, for example, using resin beads or large granular particles of media. Such a device would offer benefits if capable of producing potable water for use in a household (point-of-use or point-of-entry service) as well as in central water treatment systems that serve a community.

### SUMMARY OF THE INVENTION

In general, the present invention features a device for treating liquid comprising a containment member including rigid porous polymer configured to form a containment space. Nonbonded particulate media is contained in the space in contact with the containment member. Pores in the containment member are characterized by pore paths and pore sizes effective to permit flow of liquid through the pores while preventing the media from traveling through the pores. The containment member may be in various shapes and sizes and may include different numbers of components. One variation of the containment member includes first and second containment layers comprised of the rigid porous polymer, which are configured and arranged so as to form a space between them in which the media is contained.

Another aspect of the invention features a radial flow cartridge for removing substances from liquid, including first and second tubes comprised of rigid porous polymer. The second tube is disposed around the first tube so as to form a space between them. Nonbonded particulate media is contained in the space in contact with the first and second tubes. End caps are connected to ends of the first and second tubes. Pores in the first and second tubes are characterized by pore paths and pore sizes effective to permit flow of liquid through the pores while preventing the media from traveling through the pores.

Another aspect of the invention features a radial flow apparatus for removing substances from liquid, which includes the radial flow cartridge disposed in a casing or housing. A cover is adapted to direct influent to and effluent from the cartridge. The cover is removably fastened to the casing in fluid communication with the cartridge.

The following refers to specific features of the inventive media that apply to any aspect of the inventive article or method in this disclosure. The media may have an average particle size of not greater than about 50 microns and, in particular, an average particle size ranging from about 5-50 microns. The media comprises metal hydroxide or metal oxide. In particular, the media is based on zirconium, titanium or iron. More specifically, suitable media includes, but is not limited to, media selected from the group consisting zirconium dioxide, hydrous zirconium oxides, granular ferric hydroxide, hydrous ferric oxides, sulfur modified iron, hydrous titanium oxides, titanium dioxide, crystalline anatase, activated alumina and combinations thereof. The media is characterized by an ability to remove arsenic-containing chemical species from liquid to levels less than 2 parts per billion. The media can also include zirconium phosphates. Other suitable media is selected from the group consisting of: a) an amorphous zirconium phosphate of H-form that exhibits a peak at −13.7±0.5 ppm in the ³¹P NMR spectra; b) amorphous hydrous zirconium oxide having a pore size distribution ranging from 20 to 40 Å, a surface area of at least 150 m²/g, an average particle size of at least 10 microns, and a stability against moisture loss characterized by a capacity and selectivity for chemical species that does not decrease more than 20% across a moisture content LOD ranging from 0<LOD<40%; c) zirconium phosphate of H form which is characterized by a ³¹P NMR spectra comprising peaks at −4.7 ppm and −17.0 ppm, each of the peaks being in a range of ±0.5 ppm, and combinations thereof.

The following refers to specific features of the inventive porous polymer containment member that apply to any aspect of the inventive article or method disclosed herein. The downstream porous polymer layer has an average pore size of not greater than about 40 microns and, in particular, an average pore size ranging from about 10-40 microns. The upstream porous polymer layer has an average pore size of not greater than 100 microns. The invention may take advantage of water flow and the resulting forces that are placed on the media, in designing the upstream porous polymer layer the liquid passes first (e.g., the outer tube) to have a greater average pore size than the downstream layer the liquid passes last (e.g., the inner tube). The media is retained primarily with the downstream porous polymer layer. Use of the more porous upstream porous polymer layer increases the flow rate through the device. A porous polymer containment member that has an average pore size of not greater than about 40 microns may be used with media that has an average particle size of not greater than about 50 microns. A 10 micron average pore size can be used to prevent loss of media having an average particle size on the order of 5 microns or more. The pore path and pore size are tailored, relative to a particle size of the media, to permit passage of liquid and prevent loss of media which, along with characteristics of the bed of media, avoid creating a pressure drop across the device more than about 35 psi. The present invention advantageously may remove chemical species that are dissolved in liquids. Such chemical species may be less than 1000 in molecular weight and, in particular, not more than 100 in molecular weight. These species are much smaller than particles suspended in a liquid. The media removes the chemical species by adsorption or ion exchange.

Another aspect of the invention generally features a method including passing liquid through pores in the containment member comprised of the rigid porous polymer. The pores are characterized by pore paths and pore sizes that permit flow of the liquid through the pores. The liquid is passed through nonbonded particulate media effective to form treated liquid. The media is contained by and in contact with the containment member. The treated liquid is removed from the device. Media is prevented from traveling through the pores due to the pore paths and pore sizes.

A more specific aspect of the inventive method includes passing liquid containing a substance to be removed radially through pores in one of first and second tubes comprised of the rigid porous polymer. The second tube is disposed around the first tube to form a space between them. The pores are characterized by certain pore paths and pore sizes. The liquid is passed radially through the nonbonded particulate media, which is contained in the space in contact with the tubes, effective to remove the substance from the liquid and to form effluent. The effluent is passed radially through the other of the first and second tubes. The media is prevented from traveling through the pores due to the pore paths and pore sizes. In the inventive method, the liquid may be water or an aqueous liquid. The liquid is passed through the device at a pressure drop of not more than about 35 psi across the device.

A further specific aspect of the inventive method features removing dissolved chemical species from drinking water. The drinking water is passed radially through pores in an upstream one of first and second tubes comprised of the rigid porous polymer. The porous polymer of the downstream tube has an average pore size of not greater than about 40 microns. The water is passed radially through the nonbonded particulate media, which is contained in the space in contact with the tubes, effective to remove the chemical species from the water by adsorption or ion exchange. This forms effluent. The media is selected from the group consisting of zirconium dioxide, hydrous zirconium oxides, granular ferric hydroxide, hydrous ferric oxides, sulfur modified iron, hydrous titanium oxides, titanium dioxide, crystalline anatase, activated alumina and combinations thereof having an average particle size of not greater than about 50 microns. The treated water is passed radially through the pores in the downstream tube. Media is prevented from traveling through the pores due to the pore paths and pore sizes. More specifically, the chemical species comprise arsenic, which is removed from the water to levels below 10 parts per billion and particular, to not greater than 2 parts per billion.

Another embodiment of the invention features a system for treating liquid comprising any aspect of the inventive article or method in this disclosure, and a pH adjuster located upstream of the liquid treatment device relative to flow of the liquid. The pH adjuster contains pH adjuster material capable of releasing H or OH groups into the liquid or consuming H or OH groups from the liquid, effective to raise or lower the pH of the liquid while it passes through the media of the downstream liquid treatment device. The pH adjuster material preferably includes particulate material in solid or slurry form, in particular, nonbonded particulate material. Cast, molded or otherwise bonded pH adjuster material might also be suitable for use in the invention.

The pH adjuster may be an acidifier including pH adjuster material capable of releasing protons into the liquid or consuming OH groups from the liquid effective to lower the pH of the liquid while it passes through the media of the downstream liquid treatment device. The acidifier material can be hydrolytically decomposed so as to consume OH. In this regard, suitable particulate acidifier material includes, but is not limited to, material selected from the group consisting of zirconium basic sulfate, zirconium basic carbonate, titanium basic sulfate, and combinations thereof. The acidifier material can operate by ion exchange substitution of protons into the feed liquid. In this regard, suitable particulate acidifier material includes, but is not limited to, material selected from the group consisting of zirconium phosphates, zirconium silicates, titanium phosphates, cation exchangers (e.g., carboxylic cation exchangers), sulfocationic ion exchange resins, and combinations thereof. The acidifier is characterized by its ability to improve the performance of the downstream media in removing chemical species from liquids, including but not limited to those selected from the group consisting of arsenic, chromium (VI), selenium, boron, phosphates and combinations thereof.

The pH adjuster may be a basifier located upstream of the inventive liquid treatment device relative to flow of the liquid. The basifier contains material capable of consuming protons from the liquid or releasing OH groups into the liquid effective to raise the pH of the liquid while it passes through the media of the downstream liquid treatment device. The basifier is characterized by its ability to improve the performance of the downstream media in removing chemical species from liquids, including, but not limited to, those selected from the group consisting of lead, cadmium, copper, barium, strontium, thallium and combinations thereof.

The inventive liquid treatment device may be used in point-of-use, point-of-entry and central water treatment services. In the point-of-use service the device is used at specific locations of a home such as under a kitchen faucet for treating drinking water. In the point-of-entry service a bank of a plurality of devices in parallel such as 2 or 3 devices, are used to treat all the water of a home. In central water treatment service a bank of a plurality of devices in parallel such as 10 to 20 devices, are used on a well or other water source to treat the water for a number of households.

The present invention offers numerous advantages over prior art liquid treatment devices and methods. The invention enables particulate media, even fine media, to be contained without the use of screens, filter paper or membranes. This results in a device that is more reliable and economical to fabricate and operate in that it avoids the fabrication costs and/or limited strength of membranes, filter paper and screens. The inventive porous polymer containment member advantageously enables liquid to travel through the pores while preventing media from traveling through the pores, without an excessive pressure drop across the device. The inventive media is advantageous in that it is extremely effective in removing chemical species from liquids. In particular, the invention can remove arsenic to levels not greater than 2 ppb and even to undetectable levels as evaluated by atomic adsorption using a graphite furnace. This may be achieved by a single pass of the liquid through a relatively thin layer of media to which the influent is relatively briefly exposed, compared to a column of media. However, the invention may apply to columns and other media bed configurations as when the media is in granular form or beads.

The invention is ubiquitous in its applicability to point-of-use, point-of-entry and central water treatment services. A desirable feature of the invention is its ease of use. A user need only periodically replace the cartridges in the apparatus, which avoids the need for environmental consultants to carry out complicated operation or maintenance.

The invention facilitates removing chemical species from liquids by ion exchange or chemical adsorption mechanisms. The porous polymer containment member is especially advantageous when used with adsorbents or ion exchange medias because it enables a uniform media bed depth to be achieved and does not impede charging of the media or suffer from channeling through the pores, which would lead to regions of non-uniform thickness in the media bed and premature breakthrough at those locations. The rigidity of the porous polymer containment member and ability to design it in various shapes and sizes with great accuracy, offer advantages over other adsorption or ion exchange devices having nonbonded particulate media and different porous components such as membranes, screens, filter paper or the like.

The inventive system that includes the pH adjuster permits very high removal of chemical species over a long life of the device. The pH adjuster can operate as an acidifier or basifier and thus, may improve the performance of a variety of medias and enable efficient removal of a variety of chemical species in different liquids and applications.

Other embodiments of the invention are contemplated to provide particular features and structural variants of the basic elements. The specific embodiments referred to as well as possible variations and the various features and advantages of the invention will become better understood when considered in connection with the accompanying drawings and the detailed description that follows.

### BRIEF DESCRIPTION OF THE DRAWINGS

FIG. 1 is a perspective view of a radial flow device constructed in accordance with the present invention;

FIG. 2 is a vertical cross-sectional view of the liquid treatment device shown in FIG. 1;

FIG. 3 is a detail view of a wall of a porous polymer tube of the device shown in FIG. 2;

FIG. 4 is a schematic drawing that shows porous polymer containment members each including flat two plates that contain the media; and

FIG. 5 is a schematic view showing the inventive liquid treatment device used in combination with an upstream pH adjuster.

### DETAILED DESCRIPTION

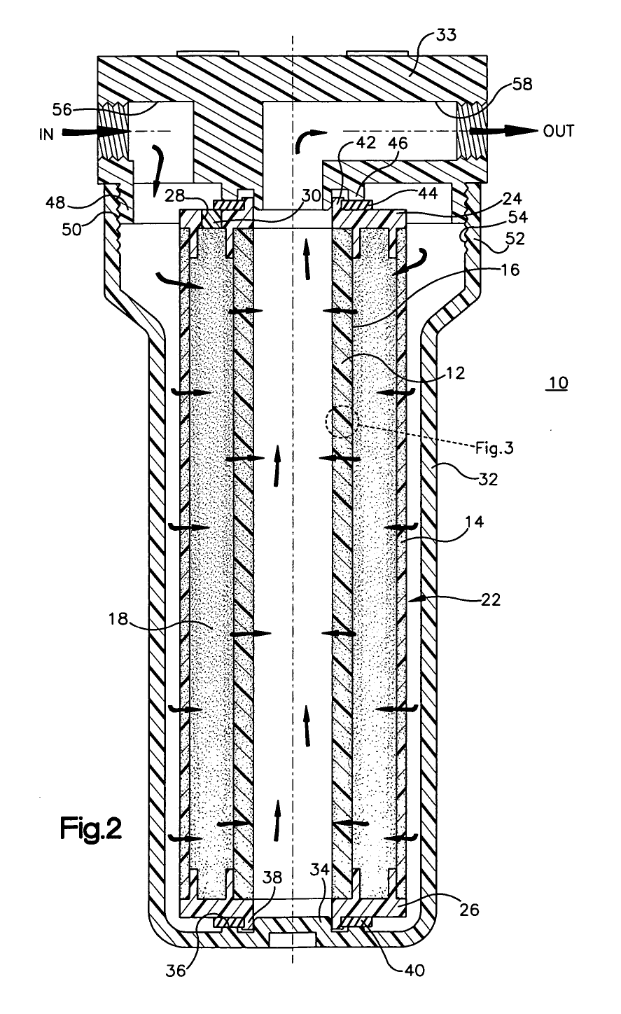

The present invention features a radial flow device 10 for treating liquids, comprising a containment member in the form of inner and outer porous polymer tubes 12, 14 (FIG. 2), which are constructed and arranged so as to form a generally annular space 16 between them. A generally annular bed of media 18 is contained in the space in contact with the first and second tubes. Pores in the porous polymer tubes are characterized by tortuous pore paths and pore sizes effective to permit flow of liquid through the pores while preventing media from traveling through the pores.

The inner tube 12 has a smaller diameter than the outer tube 14. The outer tube 14 is disposed around and concentric with the inner tube 12. Liquid travels generally radially through the porous polymer tubes and media as shown by the arrows in FIG. 2. In particular, influent or untreated liquid passes from outside the outer tube, generally radially through the outer tube, generally radially through the media to form effluent and generally radially through the inner tube and axially from the device. Conversely, influent may enter the central opening of the inner tube and travel in the reverse direction, in which case the influent would travel generally radially outwardly through the inner tube, generally radially outwardly through the media and then the effluent would travel generally radially outwardly through the outer tube, and axially from the device. Reference to generally radial travel describes the predominantly radial flow of the liquid but allows for variation in flow direction through the device that would be apparent to those skilled in the art in view of this disclosure.

While the detailed description illustrates an embodiment of the invention that includes porous polymer tubes, those skilled in the art will appreciate that the invention applies to other porous polymer containment members and/or layers, which are not in the shape of tubes. In addition, it will be appreciated that various terms are used herein to improve understanding but should not be used to limit the invention, such as upper, lower, inner, outer, influent, effluent, large, small and the like. Also, FIG. 3 is intended to provide a general understanding of the pore morphology and tortuous characteristics of the inventive porous polymer tubes. The actual microstructure of the porous polymer would be evident from viewing the microstructure of the material as shown, for example, in scanning electron micrographs (SEMs). FIG. 3 should not be used to limit the scope of the present invention, including pore length, size or shape, particle size or shape, or the size or shape of the tubes or media bed.

The radial flow device comprises a removable cartridge 22. The cartridge includes the inner and outer tubes and media as described above, and upper and lower end caps 24 and 26 as shown in FIG. 2. The end caps are connected to the ends of the tubes and prevent media from leaving ends of the space. The end caps may be fastened to the tubes in a manner known to those skilled in the art, such as by potting, which involves pouring a resin into a mold in which the two tubes are set and allowing the resin to harden; and, in the case of machined or injection molded end caps, by gluing, or by heat or solvent welding. The end cap 24 may contain openings 28 that facilitate charging the media into the cartridge and plugs 30 that cover the openings after charging. Other techniques and structural features for charging media into the cartridge would be apparent to those skilled in the art in view of this disclosure. For example, media could be charged into the space between tubes to which a lower end cap is fastened and then the upper end cap could be fastened to the tubes. In this case, charging openings and plugs may not be needed.

The cartridge is removably disposed in an outer generally cylindrical casing 32. Attached to the casing is a cover 33. The casing includes a lower boss 34 and annular protrusion 36. The lower end cap includes an optional annular lip 38. An optional annular seal or gasket 40 is seated around the lip 38 and compressed between the lower end cap and the protrusion 36. The seals or gaskets and lips may not be needed. For example, in the case of potted end caps the potted end cap material can be polyurethane that is soft enough to deform and directly form a seal against protrusion 36. The boss 34 is received in the central opening of the inner tube and locates the cartridge in position. The upper end cap includes an optional annular lip 42. An optional annular seal or gasket 44 is seated around the lip 42 and compressed between the upper end cap and a projection 46 of the cover 33. Alternatively, an upper, potted end cap would be compressed against the projection 46 of the cover. The seals and end caps may be made of elastomer or other suitable material. Other structures for sealing the cartridge in the casing would be apparent to those skilled in the art in view of this disclosure.

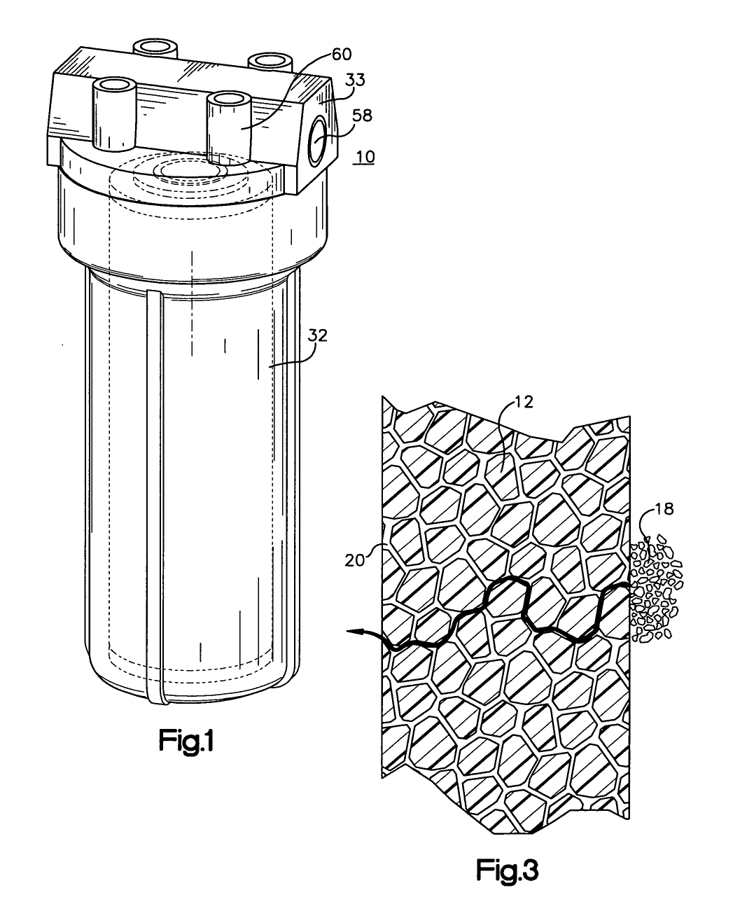

The cover 33 is removably fastened to the casing in fluid communication with the cartridge. The cover may include a smaller diameter portion 48 that extends into the casing and includes exterior threads 50. A corresponding upper portion 52 of the casing includes interior threads 54 that engage the exterior threads 50 to fasten the cover to the casing and to compress the seals or the end caps. The cover includes an inlet opening 56 for directing influent into the cartridge and an outlet opening 58 for directing effluent from the cartridge. The cover may include mounting structures, such as interiorly threaded tubes shown generally shown at 60 (FIG. 1), enabling it to be connected to fasteners such as beneath a household sink, in a well known manner of conventional water filter cartridges.

As shown in FIG. 3, the tortuous pore paths and pore size, i.e., pore length and pore area, are tailored, relative to an average particle size of the media, to permit passage of liquid while preventing loss of media through the pores. One possible tortuous pore path for fluid travel is shown by an arrow in FIG. 3. The porous polymer tubes can be manufactured by the supplier company to specification regarding specified inner and outer diameter, thickness, and pore sizes. The pores have a size and length that are tailored, relative to a particle size of the media, to permit passage of liquid and to prevent loss of media which, along with characteristics of the bed of media, avoid creating an excessive pressure drop across the device more than about 35 psi. Excessive pressure drop can be caused by a number of factors including excessive thickness or depth of the media bed, inadequate pore size, and excessive pore paths (e.g., excessive thicknesses of the tubes). The average pore size is less than or approximately equal to an average particle size of the media. The ability to employ a pore size that can approximate the particle size of the media is surprising and is possible as a result of the tortuous pore paths that prevent loss of media through the pores.

The porous polymer tubes can have an average pore size of not greater than about 40 microns and, in particular, an average pore size in the range of about 10-40 microns. An unexpected result of the invention is that a particular average pore size of the porous polymer tube (e.g., 10 microns) can be used to prevent loss of media having a smaller average particle size (e.g., on the order of 5 microns or more).

In a preferred form, the device does not include any screen, membrane or filter paper. An average pore size of the porous polymer tubes is greater than a size that can strain dissolved chemical species from the liquid. The porous polymer tubes function to contain the media, not to filter suspended particles from the feed liquid. The porous polymer tubes are rigid or self-supporting, i.e., they support themselves without being formed with or supported by other rigid members. The porous polymer tubes have a thickness and stiffness much greater than that of a membrane, screen or filter paper. For example, the porous polymer tubes can have a thickness of ¼ inch or more.

Suitable porous polymer tubes include Porex™ brand porous polymer tubes supplied by Porex Technologies Corp., such as disclosed in U.S. Pat. No. 4,761,232. Suitable polymers for Porex™ brand porous polymer tubes may include polyethylene, polypropylene, polytetrafluoroethylene, polyvinylidene fluoride, ethyl vinyl acetate, Nylon 6, thermoplastic polyurethane, and co-polymers of polyethylene and polypropylene. Other suitable polymers for the porous polymer tubes would be appreciated by those skilled in the art in view of this disclosure. Other suppliers of porous polymer tubes that may be suitable for use in the present invention are MA Industries, Gopani Product Systems, Porvair Filtration Group, Ltd., and II Sung Porous Co.

The media is a nonbonded particulate that may take the form of a powder, paste, slurry, beads, granulation or other particulate form. The media may be made by being ground, granulated, precipitated, evaporated from a solution by spray drying or other drying technique, by attaching to a particulate substrate, or by other means known to the art or disclosed in U.S. Pat. No. 6,383,395 and U.S. patent application Ser. Nos. 10/195,630, 10/195,875 and 10/195,876, which are incorporated herein by reference for all purposes in their entireties. The terms nonbonded particulate media mean that the media includes particles that are not cast, molded or embedded in a paper, membrane or other matrix, or otherwise bonded so as to be fixed in place. The term nonbonded does not imply that the media must be used in a cartridge and the invention is not limited to use of cartridges, per se. The term nonbonded does not exclude media incorporated in or onto supports such as resin beads or the like. However, preferred media does not employ resin and is not formed as resin beads because this can limit the reactivity of the media. The media bed may be a thin layer, column or other shape.

The media may comprise metal hydroxides or metal oxides. In particular, the media is based on zirconium, titanium or iron. A particularly preferred media is selected from the group consisting of zirconium dioxide, hydrous zirconium oxides, granular ferric hydroxide, hydrous ferric oxides, sulfur modified iron, hydrous titanium oxides, titanium dioxide, crystalline anatase as disclosed in U.S. 2003/0155302, which is incorporated herein by reference in its entirety, activated alumina and combinations thereof. Other suitable media, which is supplied by Magnesium Elektron Inc., is selected from the group consisting of: a) an amorphous zirconium phosphate of H-form that exhibits a peak at −13.7±0.5 ppm in the ³¹P NMR spectra; b) amorphous hydrous zirconium oxide having a pore size distribution ranging from 20 to 40 Å, a surface area of at least 150 m²/g, an average particle size of at least 10 microns, and a stability against moisture loss characterized by a capacity and selectivity for chemical species that does not decrease more than 20% across a moisture content LOD ranging from 0<LOD<40%; c) zirconium phosphate of H form which is characterized by a ³¹P NMR spectra comprising peaks at −4.7 ppm and −17.0 ppm, each of the peaks being in a range of ±0.5 ppm, and combinations thereof, as described in U.S. patent application Ser. Nos. 10/195,630, 10/195,875 and 10/195,876; and media described in U.S. Pat. No. 6,383,395.

With the exception of zirconium phosphates, the media can remove arsenic to levels under 10 parts per billion (ppb), and in particular, to levels not greater than 2 ppb billion, after a single pass of the liquid through the media. The media can remove arsenic from liquid to undetectable levels as evaluated by atomic adsorption using a graphite furnace. The average particle size of the media can be up to about 50 microns and, in particular, in the range of about 5-50 microns. The media, even though it may have a fine particle size, advantageously does not cause an excessive pressure drop across the media bed.

Although the media may be characterized by an ability to remove arsenic-containing species from liquid, it may remove other species instead of or in addition to arsenic-containing species. The media can remove anionic chemical species selected from the group consisting of: chromium (VI), selenium, boron, phosphates, and combinations thereof. The media may also remove cationic chemical species including lead, cadmium, copper, barium, strontium, thallium and combinations thereof. Other chemical species that may be removed by the media are discussed in U.S. Pat. No. 6,383,395 and U.S. patent application Ser. Nos. 10/195,630, 10/195,875 and 10/195,876.

The media removes molecular species from solution by chemical adsorption and/or ion exchange. The dissolved small chemical species have a molecular weight less than 1000 and usually not more than 100.

The invention may advantageously be usable for treating a variety of liquids including drinking water, aqueous liquids, industrial effluents, industrial process streams, contaminated ground water, beverages, wines, and liquors. The invention may be used on a commercial scale such as for treating drinking water in one or more households or in a community.

In operation of the device, untreated water or other fluid (influent) enters the inlet of the cover and travels into the annular space between the casing and the cartridge. The influent flows generally radially through the pores in the outer tube, across an entire length of the outer tube. The pores in the outer tube do not substantially impede flow of influent through it. The influent travels generally radially inwardly through the media, across a length of the media. The media removes chemical species from the liquid by adsorption or ion exchange. The treated liquid or effluent having the chemical species removed, then flows generally radially from the media through the pores of the inner tube, across the entire length of the inner tube. The pores in the inner tube do not substantially impede flow of effluent through it. From the inner tube the effluent enters the central passage along the entire length of the inner tube. The effluent then travels generally axially through the passage and through the outlet opening in the cover. While the tortuous pore paths in the inner and outer tubes do not substantially inhibit fluid flow through them, they prevent media from traveling through them. When the media's ability to remove chemical species from the influent has been reduced to undesirable levels, the cover is unscrewed and the spent cartridge is removed from the device. The spent cartridge is replaced by a cartridge containing fresh media.

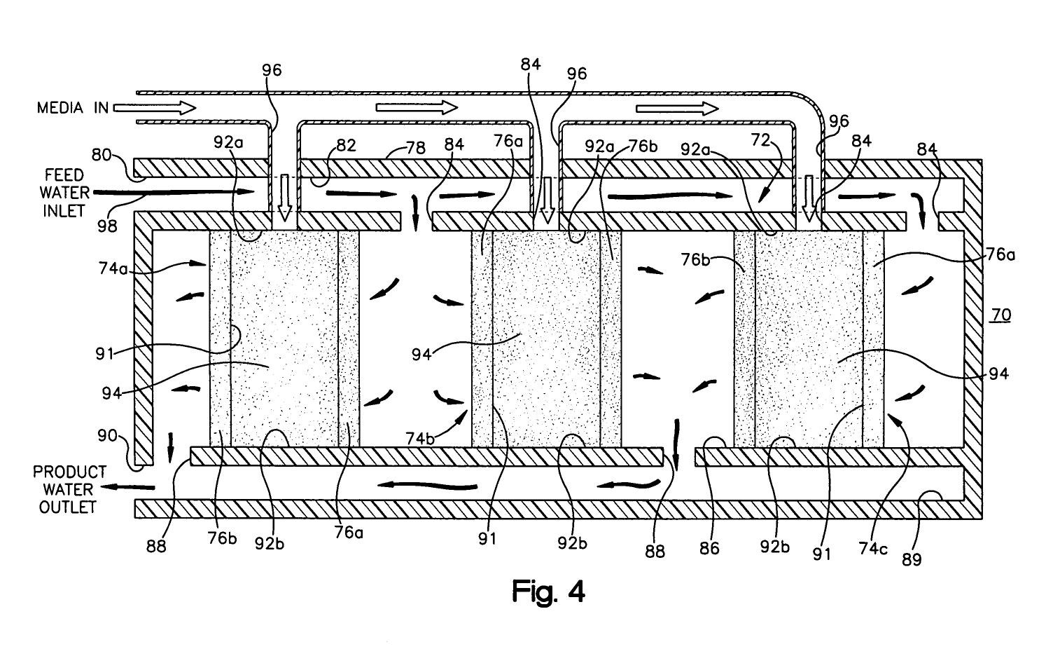

Another embodiment of the present invention shown in FIG. 4, features a central water treatment apparatus 70 that uses a bank of liquid treatment devices 74a, b, c, each including upstream and downstream porous polymer containment layers 76a, b. The apparatus includes a housing 78 having an inlet 80 leading to an inlet passage 82 that feeds liquid to a plurality of inlet openings 84 into a chamber 86. A plurality of outlet openings 88 in the chamber feed to an outlet passage 89 extending to an outlet 90 of the housing. The bank 72 of liquid treatment devices is disposed in the chamber 86. Each of the devices includes the opposing flat porous polymer plates that form a space 91 between them. The walls of the chamber 86 contain the media along surfaces 92a, b transverse to the porous plates. Media 94 is contained in the space 91 in contact with the plates 76a, b and chamber walls 92a, b. The porous polymer plates and media have the same characteristics as described above in this disclosure. The tortuous pore paths and pore sizes of the plates permit the passage of the liquid while preventing the media from passing through the plates.

Media may be charged into the devices 74a, b, c through pipes 96 that have a smaller size than the inlet passage 82.

In operation, influent 98 enters the inlet of the housing and travels along the inlet passageway. The influent travels though each inlet into the chamber, through an upstream porous plate 76a and into each of the liquid treatment devices 74a, b, c. Substances in the liquid such as chemical species are removed by the media through adsorption or ion exchange. The effluent passes though the downstream porous polymer plate 76b and leaves the chamber through an adjacent outlet opening. The effluent travels along the outlet passageway 89 and leaves through the outlet 90 of the housing. Other examples of apparatuses that include the containment member and media bed in other arrangements and shapes would be apparent to those skilled in the art in view of this disclosure.

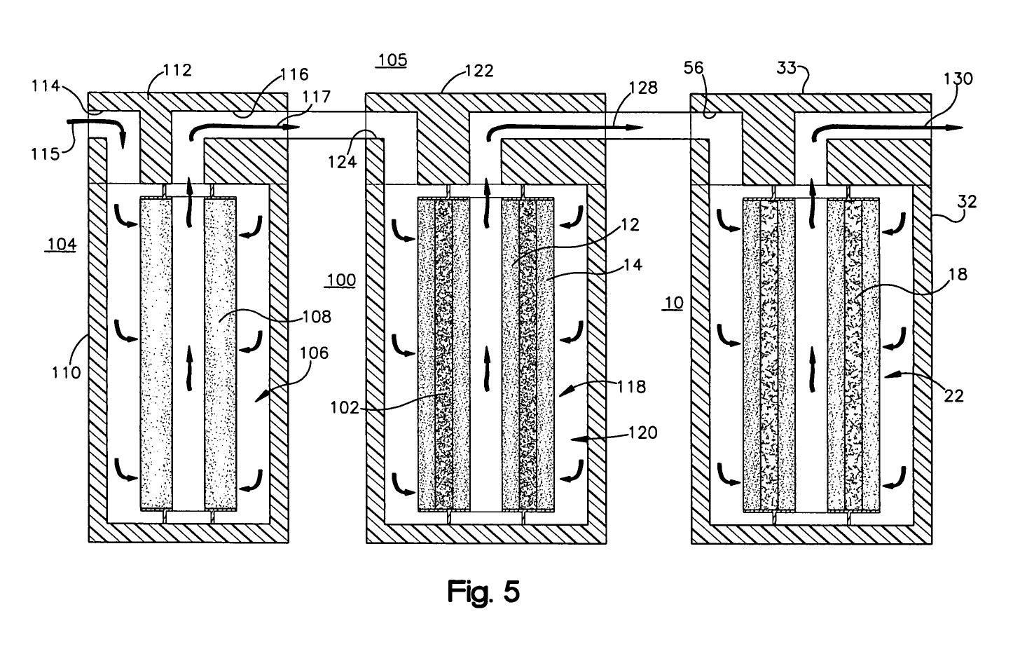

Another embodiment of the invention is shown in FIG. 5, where like reference numerals represent like parts throughout the several views of this disclosure. An inventive system 105 employs pH adjuster device 100 containing pH adjuster material 102, upstream of the liquid treatment apparatus 10 in the liquid flow direction shown by the arrows in the figure. The pH adjuster raises or lowers the pH of water or other liquid such that when it passes through the media 18 in the downstream liquid treatment device, the ion exchange and/or adsorption performance of the media 18 is greatly improved. The invention may also employ a prefilter device 104 located upstream of the pH adjuster device 100 for removing suspended particles in advance of the liquid treatment device 10.

In particular, the pH adjuster may be an acidifier that advantageously improves the ability of the media to remove arsenic from liquids. Removal of other chemical species with the media, that may be improved by the lower pH provided by the acidifier, are anionic chemical species selected from the group consisting of: chromium (VI), selenium, boron, phosphates, and combinations thereof. The pH adjuster may take the form of a basifier, in processes where the media of the liquid treating device 10 could benefit from passing the liquid through the media at an increased pH provided by the basifier. This may promote the removal of cationic chemical species with the media, including lead, cadmium, copper, barium, strontium, thallium and combinations thereof.

While not wanting to be bound by theory, the mechanism of the acidifier action can be hydrolytic decomposition of the compound with the consumption of free OH or ion exchange substitution of mobile protons in compound by cations from purified solution. Examples of unbonded particulate material suitable for consuming OH include zirconium basic sulfate, zirconium basic carbonate, titanium basic sulfate and combinations thereof. Examples of suitable unbonded particulate cation exchange adsorbents in H-form (i.e., pH adjuster material) include, but are not limited to, zirconium phosphates, zirconium silicates, titanium phosphates, cation exchangers (e.g., weak acid carboxylic cation exchangers: Amberlite IRC50, Amberlite IRC-76, IMCA HP-333 and Lewatit S8227 from Sybron Chemical Inc.), sulfocationic ion exchange resins and combinations thereof. Similarly, the mechanism for solid basifier action can be consumption of H or addition of OH groups using an anion exchanger.

The pH adjuster device 100 may be designed as a radial flow device in the manner of the liquid treatment device 10 or as an axial flow device. An axial flow pH adjuster device would include the pH adjuster material in an axial flow cartridge such as an empty axial flow cartridge purchased from Flowmatic Systems, Inc.

One preferred aspect of the invention is the three-device system 105 shown in FIG. 5 comprising, in order from upstream to downstream: the prefilter device 104 containing a material that filters particulates from the liquid, the pH adjuster device 100 and the radial flow liquid treatment apparatus 10.

The prefilter device 104 includes a cartridge 106 containing prefilter material 108 that has openings that allow passage of the liquid but not particulates. The prefilter does not remove dissolved contaminants. The prefilter may remove suspended particles from the liquid having a size of, for example, from about 0.2-5.0 microns. The device includes a casing 110 in which the cartridge is sealed and disposed in a known manner and a cover 112 that is fastened to the casing. The cover has an inlet 114 that directs influent 115 to the cartridge and an outlet 116 that directs effluent 117 from the device.

The effluent 117 from the prefilter device, having suspended solids removed from the liquid, travels to the downstream pH adjuster device 100. The pH adjuster device includes a cartridge 118 that contains the pH adjuster material 102, preferably in the form of nonbonded particulate material. The cartridge 118 can take the form of the cartridge 22 described above in connection with the liquid treatment device and include inner and outer tubes 12, 14 made of the porous polymer material. The cartridge 118 is sealed and disposed in a casing 120. A cover 122 is fastened to the casing. The cover has an inlet 124 through which the fluid 117 enters the casing and travels to the cartridge, and an outlet 126 that directs effluent 128 from the device. The liquid 128 has a pH that is raised or lowered relative to the pH of the liquid 117, but nevertheless still contains the dissolved substances to be removed. In the case of functioning of the device 100 as an acidifier, the pH of the liquid 128 is lowered compared to the pH of liquid 117, while passing through the downstream liquid treatment device 10.

The liquid 128 travels though inlet 56 in the cover of the device 10, to the cartridge 22 where it is treated by the media 18 to remove chemical species by adsorption or ion exchange. The pH adjuster device 100 as acidifier increases the lifetime of operation or capacity of the media 18 of the liquid treatment device 10 in removing arsenic without breakthrough, for example, by at least a factor of about 4. The effluent 130 leaves the device 10 through the outlet 58 of the cover and has chemical species removed therefrom.

One specific example of the three device system 105 includes a prefilter device having cartridge 106 containing a standard prefilter material or other prefilter material such as activated carbon prefilter material 108 (e.g., KDF™ activated carbon supplied by Flowmatic, Inc.), a solid acidifier device 100 having cartridge 118 containing Amberlite™ IRC-76 carboxylic cation exchanger nonbonded particulate material supplied by Rohm and Haas or IMCA HP-333 supplied by Rohm and Haas and the radial flow liquid treatment device 10 having cartridge 22 containing 302M grade hydrous zirconium oxide media 18 supplied by Magnesium Elektron, Inc.

Although the invention has been described in its preferred form with a certain degree of particularity, it will be understood that the present disclosure of preferred embodiments has been made only by way of example and that various changes may be resorted to without departing from the true spirit and scope of the invention as hereafter claimed.

1. A device for treating liquid comprising:
a containment member comprised of rigid porous polymer configured to form a containment space; and
nonbonded particulate media contained in said space in contact with said containment member;
wherein pores in said containment member are characterized by pore paths and pore sizes effective to permit flow of liquid through said pores while preventing said media from traveling through said pores.

2. A system for treating liquid comprising the device of claim 1 and a pH adjuster located upstream of said device relative to flow of the liquid, said pH adjuster containing material capable of releasing H or OH groups into the liquid or consuming H or OH groups from the liquid effective to raise or lower the pH of the liquid while it passes through said media.

3. The system of claim 2 wherein said pH adjuster is an acidifier and said material is adapted to release protons into the liquid or consume OH groups from the liquid effective to lower the pH of the liquid while it passes through said media.

4. The system of claim 3 wherein said material is adapted to be hydrolytically decomposed to consume said OH.

5. The system of claim 3 wherein said material is selected from the group consisting of zirconium basic sulfate, zirconium basic carbonate, titanium basic sulfate, and combinations thereof.

6. The system of claim 3 wherein said material is adapted to operate by ion exchange substitution of protons into the liquid.

7. The system of claim 3 wherein said material is selected from the group consisting of zirconium phosphates, zirconium silicates, titanium phosphates, cation exchangers, sulfocationic ion exchange resins, and combinations thereof.

8. The system of claim 3 wherein said media is characterized by being able to remove chemical species from liquids selected from the group consisting of arsenic, chromium (VI), selenium, boron, phosphates and combinations thereof.

9. The system of claim 2 wherein said pH adjuster is a basifier and said material is adapted to consume protons from the liquid or release OH groups into the liquid effective to raise the pH of the liquid while it passes through said media.

10. The system of claim 9 wherein said media is characterized by being able to remove chemical species from liquids selected from the group consisting of lead, cadmium, copper, barium, strontium, thallium and combinations thereof.

11. A device for treating liquid, comprising:
a first containment layer comprised of rigid porous polymer;
a second containment layer comprised of rigid porous polymer, said first containment layer and said second containment layer being configured and arranged so as to form a space therebetween;
nonbonded particulate media contained in said space in contact with said first containment layer and said second containment layer;
wherein pores in said first containment layer and said second containment layer are characterized by pore paths and pore sizes effective to permit flow of liquid through said pores while preventing said media from traveling through said pores.

12. A radial flow cartridge for removing substances from liquid, comprising:
a first tube comprised of rigid porous polymer;
a second tube comprised of rigid porous polymer, said second tube being disposed around said first tube so as to form a space therebetween;
nonbonded particulate media contained in said space in contact with said first tube and said second tube; and
end caps connected to ends of said first tube and said second tube;
wherein pores in said first tube and said second tube are characterized by pore paths and pore sizes effective to permit flow of liquid through said pores while preventing said media from traveling through said pores.

13. The radial flow cartridge of claim 12 wherein said media has an average particle size of not greater than about 50 microns.

14. The radial flow cartridge of claim 12 wherein one of said first tube and said second tube is located downstream of the other tube in a direction of liquid flow and said porous polymer in said downstream tube has an average pore size of not greater than about 40 microns.

15. The radial flow cartridge of claim 14 wherein said media has an average particle size of not greater than about 50 microns.

16. The radial flow cartridge of claim 12 wherein said media comprises metal hydroxide or metal oxide.

17. The radial flow cartridge of claim 12 wherein said media is based on zirconium, titanium or iron.

18. The radial flow cartridge of claim 12 wherein said media is selected from the group consisting of zirconium dioxide, hydrous zirconium oxides, granular ferric hydroxide, hydrous ferric oxides, sulfur modified iron, hydrous titanium oxides, titanium dioxide, crystalline anatase, activated alumina and combinations thereof.

19. The radial flow cartridge of claim 12 wherein said media is selected from the group consisting of: a) an amorphous zirconium phosphate compound of H-form that exhibits a peak at −13.7±0.5 ppm in the ³¹P NMR spectra; b) amorphous hydrous zirconium oxide having a pore size distribution ranging from 20 to 40 Å, a surface area of at least 150 m²/g, an average particle size of at least 10 microns, and a stability against moisture loss characterized by a capacity and selectivity for chemical species that does not decrease more than 20% across a moisture content LOD ranging from 0<LOD<40%; c) zirconium phosphate of H form which is characterized by a ³¹P NMR spectra comprising peaks at −4.7 ppm and −17.0 ppm, each of said peaks being in a range of ±0.5 ppm, and combinations thereof.

20. The radial flow cartridge of claim 12 wherein said media is characterized by an ability to remove arsenic-containing chemical species from the liquid to levels not greater than 2 parts per billion.

21. The radial flow cartridge of claim 12 wherein said pore paths and pore sizes are tailored, relative to an average particle size of said media, to permit passage of the liquid and to prevent loss of said media without creating a pressure drop across said cartridge more than about 35 psi.

22. A radial flow apparatus for removing substances from liquid, comprising:
the radial flow cartridge of claim 12;
a casing in which said cartridge is disposed; and
a cover for directing influent to and effluent from said cartridge, said cover being removably fastened to said casing in fluid communication with said cartridge.

23. An apparatus for removing substances from liquid comprising a plurality of said devices of claim 11 arranged in parallel relative to flow of the liquid.

24. A system for treating liquid comprising the radial flow apparatus of claim 22 and an acidifier located upstream of said device relative to flow of the liquid, said acidifier comprising a cartridge containing nonbonded particulate material capable of releasing protons into the liquid or consuming OH groups from the liquid effective to lower the pH of the liquid while it passes through said media.

25. A system for removing substances from liquid, comprising:
a radial flow apparatus comprising:
a cartridge comprising:
i) a first tube and a second tube comprised of rigid porous polymer, said second tube being disposed around said first tube so as to form a space therebetween, and
ii) nonbonded particulate media contained in said space, said media being selected from the group consisting of zirconium dioxide, hydrous zirconium oxides, granular ferric hydroxide, hydrous ferric oxides, sulfur modified iron, hydrous titanium oxides, titanium dioxide, crystalline anatase, activated alumina and combinations thereof, said media being capable of removing arsenic-containing species from the liquid to levels not greater than 2 parts per billion;
wherein one of said first tube and said second tube is located downstream of the other in a direction of liquid flow, wherein said media has an average particle size of not greater than about 50 microns and said porous polymer in said downstream tube has an average pore size of not greater than about 40 microns, and wherein said pore paths and pore sizes are tailored, relative to said average particle size of said media, to permit passage of liquid and to prevent loss of said media without creating a pressure drop across said cartridge more than about 35 psi; and
iii) end caps connected to ends of said first tube and said second tube;
an outer casing in which said cartridge is removably disposed; and
a cover for directing influent to and effluent from said cartridge, said cover being removably fastened to said casing in fluid communication with said cartridge; and
an acidifier located upstream of said radial flow apparatus, said acidifier comprising a cartridge containing nonbonded particulate material capable of releasing protons into the liquid or consuming OH groups from the liquid effective to lower the pH of the liquid while it passes through said media.

26. A method of treating liquids comprising:
passing a liquid through pores in a containment member comprised of rigid porous polymer, said pores being characterized by pore paths and pore sizes, said containment member being configured to form a space;
passing the liquid through nonbonded particulate media that is contained in said space in contact with said containment member effective to form treated liquid;
removing the treated liquid from the device; and
preventing media from traveling through said pores due to said pore paths and pore sizes.

27. The method of claim 26 comprising passing the liquid through a pH adjuster containing pH adjuster material located upstream of said device relative to flow of the liquid, and
releasing H or OH groups into the liquid or consuming H or OH groups from the liquid via said pH adjuster material effective to raise or lower the pH of the liquid while it passes through said media.

28. A method for removing a substance from liquid, comprising:
passing a liquid containing a substance to be removed radially through pores in one of a first tube and a second tube comprised of rigid porous polymer, said second tube being disposed around said first tube so as to form a space therebetween, wherein said pores are characterized by pore paths and pore sizes;
passing the liquid radially through nonbonded particulate media that is contained in said space in contact with said first tube and said second tube effective to remove the substance from the liquid and to form effluent;
passing the effluent radially through the other of said first tube and said second tube; and
preventing media from traveling through said pores due to said pore paths and pore sizes.

29. The method of claim 28 one of said first tube and said second tube being located downstream of the other in a direction of liquid flow, wherein said media has an average particle size of not greater than about 50 microns and said porous polymer in said downstream tube has an average pore size of not greater than about 40 microns.

30. The method of claim 28 wherein said media is selected from the group consisting of zirconium dioxide, hydrous zirconium oxides, granular ferric hydroxide, hydrous ferric oxides, sulfur modified iron, hydrous titanium oxides, titanium dioxide, crystalline anatase, activated alumina and combinations thereof.

31. The method of claim 28 comprising removing arsenic-containing chemical species from the liquid to levels not greater than 2 parts per billion.

32. The method of claim 28 wherein said media is selected from the group consisting of: a) an amorphous zirconium phosphate compound of H-form that exhibits a peak at −13.7±0.5 ppm in the ³¹P NMR spectra; b) amorphous hydrous zirconium oxide having a pore size distribution ranging from 20 to 40 Å, a surface area of at least 150 m²/g, an average particle size of at least 10 microns, and a stability against moisture loss characterized by a capacity and selectivity for chemical species that does not decrease more than 20% across a moisture content LOD ranging from 0<LOD<40%; c) zirconium phosphate of H form which is characterized by a ³¹P NMR spectra comprising peaks at −4.7 ppm and −17.0 ppm, each of said peaks being in a range of ±0.5 ppm, and combinations thereof.

33. The method of claim 28 wherein the liquid is water, comprising passing said water through said device at a household water flow rate without a pressure drop across said device more than about 35 psi.

34. The method of claim 28 comprising removing a chemical species from the liquid selected from the group consisting of arsenic, chromium (Vl), selenium, boron, phosphates, lead, cadmium, copper, barium, strontium, thallium, and combinations thereof.

35. A method for removing dissolved chemical species from drinking water, comprising:
passing the drinking water radially through pores in an upstream one of a first tube and a second tube comprised of rigid porous polymer, said second tube being disposed around said first tube so as to form a space therebetween, wherein said pores in said first tube and said second tube are characterized by pore sizes and pore paths, wherein said porous polymer in the other downstream tube has an average pore size of not greater than about 40 microns;
passing said water radially through nonbonded particulate media that is contained in said space in contact with said first tube and said second tube effective to remove by adsorption or ion exchange the chemical species from the water to form effluent, wherein said media is selected from the group consisting of zirconium dioxide, hydrous zirconium oxides, granular ferric hydroxide, hydrous ferric oxides, sulfur modified iron, hydrous titanium oxides, titanium dioxide, crystalline anatase, activated alumina and combinations thereof, said media having an average particle size of not greater than about 50 microns;
passing the treated water radially through said pores in said downstream tube; and
preventing said media from traveling through said pores due to said pore paths and pore sizes.

36. The method of claim 35 wherein said chemical species comprise arsenic, comprising removing said arsenic from the water to levels not greater than 2 parts per billion.

37. The method of claim 35 comprising:
passing the water through a solid acidifier containing particulate nonbonded material located upstream of said device relative to flow of the liquid, and
releasing H groups into the liquid or consuming OH groups from the liquid via said material effective to lower the pH of the liquid while it passes through said media.
